(19) United States
(12) Patent Application Publication
(10) Pub. No.: US 2015/0300826 A1
(43) Pub. Date: Oct. 22, 2015

(54) NAVIGATION SYSTEM

(71) Applicant: DENSO CORPORATION, Kariya-city, Aichi (JP)

(72) Inventor: Mitsuhisa HAYASHI, Chiryu-city (JP)

(21) Appl. No.: 14/442,770

(22) PCT Filed: Nov. 19, 2013
(86) PCT No.: PCT/JP2013/006768

§ 371 Date: May 14, 2015

(30) Foreign Application Priority Data
Dec. 3, 2012 (JP) 2012-264573

(51) Int. Cl. G01C 21/28

(52) U.S. Cl. CPC G01C 21/28

(57) ABSTRACT

Provided is a technology for conducting route guidance with high accuracy regardless of type of terminal or the software environment in a navigation system in which an onboard apparatus displays route guidance information received from a portable terminal. The navigation system includes a self-contained navigation sensor mounted in a vehicle; a mobile terminal having a GPS receive and creating and sending route guidance information for a destination; and an onboard apparatus displaying the route guidance information received from the mobile terminal. The onboard apparatus creates a corrected current position based on a current position detected by the GPS receiver and position change information detected by the self-contained navigation sensors, and sends the corrected current position to the mobile terminal. The mobile terminal creates route guidance information based on the corrected current position and map information received from the onboard device.

### CROSS REFERENCE TO RELATED APPLICATION

This application is based on Japanese Patent Application No. 2012-264573 filed on Dec. 3, 2012, the content of which is incorporated herein by reference.

### TECHNICAL FIELD

The present disclosure is related to a navigation system in which route guidance information received from a portable terminal is displayed on a display unit of an onboard apparatus.

### BACKGROUND ART

In recent years, with the spread of portable terminal having a navigation function, there is also the spread of inexpensive in-vehicle apparatuses which do not have navigation function but only display the route guidance information received from the portable terminal (for example, refer to Patent Document 1).

According to Patent Document 1, in order to improve the accuracy of the route guidance by the portable terminal, signals of a vehicle speed sensor or a steering angle sensor are transmitted from the onboard apparatus to the portable terminal. By use of these signals, the portable terminal compensates the current position detected by a GPS receiver.

### PRIOR ART LITERATURE

### Patent Literature

Patent Literature 1: JP-2009-103521 A

### SUMMARY OF INVENTION

The navigation functions of the portable terminals vary greatly depending on models and software environments (such as OS and application software) of the portable terminals. Therefore, even if the improvement of accuracy in route guidance is aimed at with the use of the signals of a vehicle speed sensor or a steering angle sensor, there is concern about the lack of general versatility.

In view of the above circumstances, it is an object of the present disclosure to provide a technology that concerns a navigation system in which an onboard apparatus displays route guidance information received from a portable terminal on a display unit, and that can perform a high-accuracy route guidance in the navigation system irrespective of models or software environments of the portable terminal.

A navigation system according to one example comprises: a self-contained navigation sensor that is mounted in a vehicle and detects position change information of the vehicle; a portable terminal that includes a GPS receiver to detect a current position, and creates and transmits route guidance information for a destination; and an onboard apparatus that displays on a display unit the route guidance information received from the portable terminal. The onboard apparatus creates a corrected current position based on the current position detected by the GPS receiver and the position change information detected by the self-contained navigation sensor, and transmits the corrected current position to the portable terminal. The portable terminal creates the route guidance information based on the corrected current position received from the onboard apparatus and map information.

According to such a navigation system, the corrected current position is created by the onboard apparatus, based on the current position detected by the GPS receiver and the position change information detected by the self-contained navigation sensor. The corrected current position created is transmitted from the onboard apparatus to the portable terminal. Based on the corrected current position and the map information, the route guidance information is created by the portable terminal.

That is, from the onboard apparatus to the portable terminal, the position change information detected by the self-contained navigation sensor is not transmitted as it is, however, the corrected current position created on the basis of the current position detected by the GPS receiver and the position change information, is transmitted. Therefore, if the portable terminal is provided with a GPS receiver, the portable terminal can support the corrected current position transmitted, irrespective of the model or software environment of the portable terminal. Therefore, it is possible to perform the route guidance with a high degree of accuracy, irrespective of the model or the software environment of the portable terminal.

### BRIEF DESCRIPTION OF DRAWINGS

The above and other objects, features and advantages of the present disclosure will become more apparent from the detailed description given hereinafter with reference to the accompanying drawings, in which:

FIG. 1 is a block diagram illustrating a navigation system provided with an onboard apparatus and a portable terminal according to one embodiment;

FIG. 2 is a sequence diagram illustrating the procedure in which an HMI controls transmission of data and displaying of route guidance information on an image display unit; and

FIG. 3 is a drawing illustrating the range of map information which the onboard apparatus acquires from a center server via the portable terminal.

### EMBODIMENTS FOR CARRYING OUT INVENTION

Hereinafter, a navigation system according to one embodiment is explained with reference to the accompanying drawings.

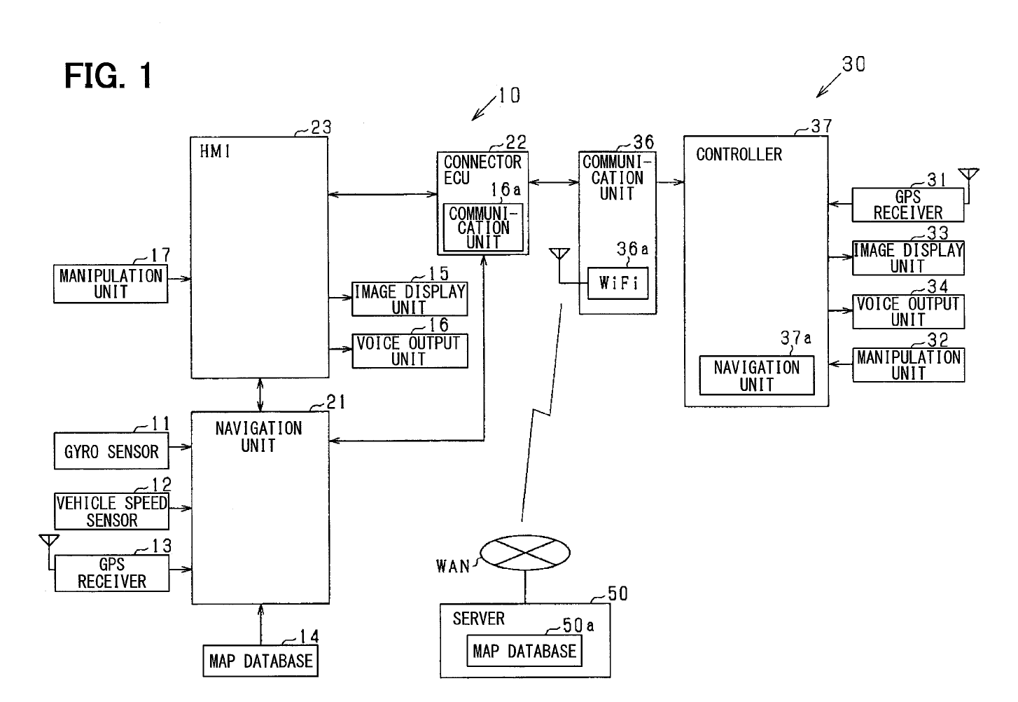

The navigation system according to the present embodiment displays either one of the route guidance information created by a portable terminal and the route guidance information created by an onboard apparatus, on a display unit of an onboard apparatus. As illustrated in FIG. 1, the navigation system includes an onboard apparatus 10 mounted in a vehicle, a self-contained navigation sensor mounted in the vehicle and provided with a gyro sensor 11 and a vehicle speed sensor 12, a GPS receiver 13 mounted in the vehicle, and a portable terminal 30 carried by a user.

The gyro sensor 11 and the vehicle speed sensor 12 detect position change information of the vehicle. Specifically, the gyro sensor 11 detects the steering amount of the vehicle from the angular velocity of the vehicle. The vehicle speed sensor 12 detects the moving distance of the vehicle based on a vehicle speed pulse sent from the vehicle at every traveling of a predetermined distance. The GPS receiver 13 receives a GPS signal from a GPS satellite and detects the current position denoted by the coordinates of longitude and latitude. Generally, the GPS receiver 13 mounted in the vehicle has a better reception sensitivity than a GPS receiver 13 of the portable terminal 30 placed in the vehicle has.

Next, a structure of the onboard apparatus 10 is explained. The onboard apparatus 10 includes a map database 14 (corresponding to an example of the map storage unit), an image display unit 15 (corresponding to an example of the display unit), a voice output unit 16, a manipulation unit 17, a navigation unit 21 (corresponding to an example of the route creation unit (means)), a connector ECU 22 (corresponding to an example of the relay unit (means)), and an HMI (Human Machine Interface) 23 (corresponding to an example of the controller (means)).

The map database 14 includes DVD equipment and/or a hard disk drive unit and stores map information. The map information includes road data and background data for denoting facilities.

The image display unit 15 includes a liquid crystal display or an organic EL (Electro Luminescence) display. The image display unit 15 is installed in a position of a passenger compartment where a user can recognize visually, and displays various images including the information about the state of the vehicle and the in-vehicle apparatus. For example, when the route guidance is under execution, the image display unit 15 displays the vehicle current position over a map and the route guidance information created by the portable terminal 30 or the onboard apparatus 10, that is, the guiding route from the current position to a destination.

The voice output unit 16 includes a speaker and outputs various voices including a voice reproduced by a music apparatus. For example, when the route guidance is under execution, the voices for guiding facilities on a map or voices for guiding the route are outputted.

The manipulation unit 17 includes manipulation switches, such as a mechanical key switch provided in an instrument panel of the vehicle and a touch switch integrated with the image display unit 15. When a user manipulates the manipulation unit 17, the state of a target apparatus is manipulated. For example, when the route guidance is under execution, a destination or search conditions of a route to the destination can be set up by the manipulation of the manipulation unit 17. When a moving image and music are played back by the image display unit 15 and the voice output unit 16, it is possible to manipulate the playback mode by the manipulation of the manipulation unit 17.

Each of the navigation unit 21, the connector ECU 22, and the HMI 23 includes a microcomputer, which includes a CPU, a ROM, a RAM, a storage unit, an I/O port, a bus line that connects these elements.

The HMI 23, the navigation unit 21, and the connector ECU 22 are connected by an in-vehicle LAN, and the HMI 23 can perform the transmission and reception of data with the navigation unit 21 and the connector ECU 22. As the standard of the in-vehicle LAN, it is possible to employ MOST (Media Oriented Systems Transport) and IEEE (IEEE stands for Institute of Electrical and Electronics Engineers) 1394. The connector ECU 22 and the navigation unit 21 are connected by an LVDS (Low Voltage Differential Signaling) cable, and the connector ECU 22 can perform the transmission and reception of image data with the navigation unit 21.

The navigation unit 21 creates a corrected current position and route guidance information for a destination, based on the map information (vehicle map information) stored in the map database 14, the current position detected by the GPS receiver 13, and the position change information detected by the gyro sensor 11 and the vehicle speed sensor 12. Specifically, the moving distance in the direction of longitude and the direction of latitude is computed from the position-information change detected by the gyro sensor 11 and the vehicle speed sensor 12. Then, the corrected current position including the longitude and the latitude is computed, based on at least one of the current position detected by the GPS receiver 13 and the computed moving distance in the direction of longitude and the direction of latitude. Accordingly, even when reception of a GPS signal is difficult, the current position of the vehicle can be computed to a high degree of accuracy. The computed corrected current position and the map information are matched to create the route guidance information about the guiding route from the corrected current position to the destination.

Here, when displaying the route guidance information created by the portable terminal 30 on the image display unit 15, the navigation unit 21 does not create the route guidance information but creates only the corrected current position and transmits the corrected current position created to the portable terminal 30.

The connector ECU 22 is provided with a communication unit 16a which makes possible wired communication or wireless communication with the portable terminal 30. It is possible to employ the communication with a USB device as the wired communication, and the communication modes such as Bluetooth (registered trademark) and Wi-Fi (registered trademark) as the wireless communication.

The connector ECU 22 converts a communication protocol between the portable terminal 30 and the onboard apparatus 10 to relay the transmission and reception of data between the portable terminal 30 and the onboard apparatus 10. Specifically, when displaying the route guidance information created by the portable terminal 30 on the image display unit 15, the corrected current position created by the navigation unit 21 is transmitted from the navigation unit 21 to the portable terminal 30, and the route guidance information created by the portable terminal 30, the corrected current position, and the map information are transmitted from the portable terminal 30 to the HMI 23.

In accordance with a configuration, the HMI 23 controls displaying of the route guidance information on the image display unit 15 and controls the transmission and reception of data by the navigation unit 21 and the connector ECU 22. Specifically, the HMI 23 controls displaying of the route guidance information on the image display unit 15, based on the configuration defining which one of the route guidance information created by the portable terminal 30 and the route guidance information created by the navigation unit 21 should be displayed on the image display unit 15.

When displaying the route guidance information created by the navigation unit 21 on the image display unit 15, the HMI 23 acts so as to transmit the corrected current position, the route guidance information, and the map information from the navigation unit 21 to the HMI 23, and acts so as to display the corrected current position and the route guidance information on a map of the image display unit 15.

When displaying the route guidance information created by the portable terminal 30 on the image display unit 15, the HMI 23 acts first so as to transmit the corrected current position created by the navigation unit 21 from the navigation unit 21 to the HMI 23 as a master of the data transmission path. Then, the HMI 23 acts so as to transmit the corrected current position from the HMI 23 to the portable terminal 30 via the connector ECU 22. Furthermore, the HMI 23 acts so as to transmit the route guidance information created by the portable terminal 30, the corrected current position, and the map information from the connector ECU 22 to the HMI23, and acts so as to display the corrected current position and the route guidance information on the map of the image display unit 15.

The HMI 23 acts so as to transmit image data, such as an opening moving image at the time when the onboard apparatus 10 and the portable terminal 30 are connected, from the navigation unit 21 to the portable terminal 30 via the connector ECU 22. If the traffic is large, the image data may not be transmitted from the navigation unit 21 to the connector ECU 22.

When displaying the route guidance information created by the portable terminal 30 on the image display unit 15, the transmission path of data becomes longer than the case where the route guidance information created by the navigation unit 21 is displayed on the image display unit 15. Therefore, when displaying the route guidance information created by the portable terminal 30 on the image display unit 15, the communication load of the onboard apparatus 10 is liable to increase. Accordingly, when displaying the route guidance information created by the portable terminal 30 on the image display unit 15, the HMI 23 restricts data other than the corrected current position to be transmitted from the navigation unit 21. Specifically, the transmission of the map information and the route guidance information from the navigation unit 21 to the HMI 23 is stopped.

Next, a structure of the portable terminal 30 is explained. The portable terminal 30 includes a GPS receiver 31, a manipulation unit 32, an image display unit 33, a voice output unit 34, a communication unit 36, and a controller 37.

The GPS receiver 31 receives a GPS signal from a GPS satellite and detects the current position of the portable terminal 30, that is, the current position of the vehicle.

The manipulation unit 32 includes manipulation switches, such as a mechanical key switch and a touch switch integrated with the image display unit 33. A user manipulates the manipulation unit 32 to manipulate a target function state.

The image display unit 33 includes a liquid crystal display or an organic EL (Electro Luminescence) display. The image display unit 33 displays various images in accordance with a function (application software) executed by the portable terminal 30.

The voice output unit 34 includes a speaker and outputs various voices including a voice reproduced by a music apparatus.

The communication unit 36 performs wired communication or wireless communication with the onboard apparatus 10. It is possible to employ the communication with a USB device as the wired communication, and the communication modes such as Bluetooth (registered trademark) and Wi-Fi (registered trademark) as the wireless communication. A Wi-Fi communication unit 36a of the communication unit 36 establishes connection with a WAN (the Internet) by use of a wireless LAN.

The controller 37 includes a microcomputer, which includes a CPU, a ROM, a RAM, a storage unit, an I/O port, and a bus line that connects these elements. The CPU executes a program stored in the ROM and the storage unit to realize various kinds of function. The controller 37 is provided with a navigation unit 37a. The navigation function is realized when a computer program is installed in the storage unit. The computer program can be installed in the storage unit through Internet and the program recording medium in which the computer program is stored.

The navigation unit 37a creates the route guidance information for a destination based on the map information and the corrected current position received from the onboard apparatus 10 via the communication unit 36. Specifically, the corrected current position and the map information, received from the onboard apparatus 10, are matched to create the route guidance information about the guiding route from the corrected current position to the destination. The map information used here may be the map information stored in the map storage unit (not shown) provided in the portable terminal 30, or may be the map information acquired from a map database 50a of a center server 50 via the Wi-Fi communication unit 36a. When displaying the route guidance information created by the onboard apparatus 10 on the image display unit 15, the navigation unit 37a does not create the route guidance information.

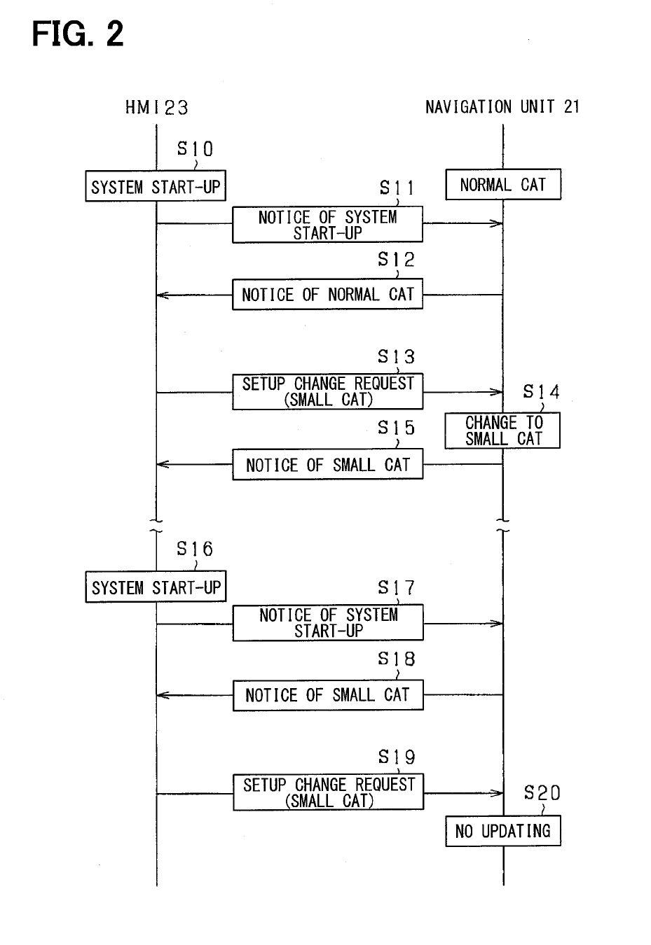

With reference to FIG. 2, the following explains a procedure for the HMI 23 to control the navigation unit 21 and the connector ECU 222 in respect of data transmission and to control the image display unit 15 in respect of displaying the route guidance information.

A memory of the navigation unit 21 stores catalogs defining communication commands to be used for the in-vehicle communication. Specifically, two catalogs are stored: one is a normal catalog to be used when displaying the route guidance information created by the navigation unit 21 on the image display unit 15, and the other is a small catalog to be used when displaying the route guidance information created by the portable terminal 30 on the image display unit 15.

The two catalogs define, for example, a communication command for navigation, a communication command for speech recognition, a communication command for audio, a communication command for dialogs, and a communication command for the system. The communication command for navigation defined in the small catalog is restricted stronger than the communication command for navigation defined in the normal catalog. Specifically, in the small catalog, a communication command to transmit the corrected current position from the navigation unit 21 to the HMI 23 is defined; however, unnecessary communication commands including a communication command to transmit the route guidance information and the map information from the navigation unit 21 to the HMI 23 are not defined.

The memory of the navigation unit 21 stores a configuration that designates which of the normal catalog and the small catalog to be used. That is, the stored configuration designates which of the route guidance information created by the onboard apparatus 10 and the route guidance information created by the portable terminal 30 to be displayed on the image display unit 15.

First, the navigation unit 21 is configured so as to use the normal catalog. At S10, the system of the onboard apparatus 10 is started up. At S11, the HMI 23 notifies the navigation unit 21 of the start-up of the system.

Upon receiving the notice of the start-up of the system from the HMI 23, the navigation unit 21 verifies that the configuration is the use of the normal catalog and notifies the HMI 23 of the normal catalog at S12.

When the route guidance is started, the HMI 23 acts so as to display on the image display unit 15 the route guidance information created by the navigation unit 21 based on the configuration designating the use of the normal catalog, and controls the transmission of data from the navigation unit 21 to the HMI 23 using the normal catalog. That is, the HMI 23 acts so as to transmit the corrected current position, the route guidance information, and the map information from the navigation unit 21 to the HMI 23. The HMI 23 controls displaying of the route guidance information based on the configuration designating the use of the normal catalog, and controls the navigation unit 21 and the connector ECU 22 in respect of the transmission and reception of data, using the normal catalog, until the configuration is changed.

Next, at S13, the HMI 23 requests the navigation unit 21 to change the configuration into the use of the small catalog. This change request is issued, for example, when a vehicle has come to the place of which the map information is not found in the map database 14. The present change request may be made by the HMI 23 according to the manipulation of the manipulation unit 17 by a user, or the present change request may be made by the HMI 23 automatically according to the judgment of the navigation system.

Upon receiving the request to change the configuration from the HMI 23, the navigation unit 21 confirms that the configuration is the use of the normal catalog, and changes the configuration into the use of the small catalog, at S14. Then, at S15, the navigation unit 21 notifies the HMI 23 of the small catalog.

When the route guidance is started, the HMI 23 acts so as to display on the image display unit 15 the route guidance information created by the portable terminal 30 based on the configuration designating the use of the small catalog, and controls the data transmission from the navigation unit 21 and the connector ECU 22 to the HMI 23, using the small catalog. That is, the HMI 23 acts so as to transmit the corrected current position from the navigation unit 21 to the HMI 23 and stops the transmission of the route guidance information and the map information. The HMI 23 also acts so as to transmit the route guidance information, the corrected current position, and the map information which have been created by the portable terminal 30 from the connector ECU 22 to the HMI 23. The HMI 23 controls displaying of the route guidance information based on the configuration designating the use of the small catalog and controls the transmission and reception of data by the navigation unit 21 and the connector ECU 22 using the small catalog, until the configuration is changed.

Subsequently, at S16, when the system of the onboard apparatus 10 is started up again, the HMI 23 notifies the navigation unit 21 of the start-up of the system at S17.

Upon receiving the notice of the start-up of the system from the HMI 23, the navigation unit 21 verifies that the use of the small catalog is configured and notifies the HMI 23 of the small catalog at S18.

Next, at S19, the HMI 23 requests the navigation unit 21 to change the configuration into the use of the small catalog.

Upon receiving the request to change the configuration into the small catalog from the HMI 23, the navigation unit 21 confirms that the configuration is the use of the small catalog and does not update the configuration, at S20. Accordingly, it is possible to prevent the memory from being consumed, due to unnecessary updating of the configuration. Hereafter, until the configuration is changed, the HMI 23 acts so as to display the route guidance information based on the configuration defining the use of the small catalog, and controls the transmission and reception of data by the navigation unit 21 and the connector ECU 22, using the small catalog.

The present embodiment described above produces the following technical effects.

From the onboard apparatus 10 to the portable terminal 30, the position change information detected by the gyro sensor 11 and the vehicle speed sensor 12 is not transmitted as it is, but the corrected current position created based on the current position detected by the GPS receiver 13 and the position change information is transmitted. Therefore, if provided with the GPS receiver 31, any portable terminal 30 can respond to the corrected current position transmitted, irrespective of its model or software environment. Accordingly, it is possible to perform the route guidance with a high degree of accuracy, irrespective of the model or software environment of the portable terminal 30.

When displaying the route guidance information created by the portable terminal 30 on the image display unit 15, the transmission of unnecessary data other than the corrected current position from the navigation unit 21 is restricted. Therefore, even if the transmission path of the data becomes long, it is possible to suppress the communication load of the onboard apparatus 10 by reducing the traffic.

When displaying the route guidance information created by the portable terminal 30 on the image display unit 15, it is possible to certainly reduce the traffic of the onboard apparatus 10 by stopping the transmission of the map information and the route guidance information from the navigation unit 21 to the HMI 23.

It is possible to easily change the route guidance information to be displayed on the image display unit 15, by changing the configuration defining which one of the route guidance information created by the portable terminal 30 and the route guidance information created by the navigation unit 21 should be displayed on the image display unit 15. When the route guidance is started, the route guidance information is displayed on the image display unit 15 based on the stored configuration; accordingly, it is possible to display the route guidance information by the same configuration as the previous time until the configuration is changed.

The embodiment described above can be modified as follows.

When displaying the route guidance information created by the portable terminal 30 on the image display unit 15, the HMI 23 may act so as to transmit the corrected current position from the navigation unit 21 to the portable terminal 30 not through the HMI 23 but through the connector ECU 22. According to this structure, the corrected current position is transmitted from the navigation unit 21 to the portable terminal 30 by the shortest route. Therefore, it is possible to suppress the communication load of the onboard apparatus 10.

The portable terminal 30 may transmit the current position detected by the GPS receiver 31 to the navigation unit 21. Then, the navigation unit 21 may create the corrected current position based on the current position received from the portable terminal 30 and the position change information detected by the gyro sensor 11 and the vehicle speed sensor 12, and may transmit the corrected current position created to the portable terminal 30. According to this structure, the onboard apparatus 10 creates the corrected current position based on the current position detected by the GPS receiver 31 of the portable terminal 30. Accordingly, it is not necessary to provide the onboard apparatus 10 with the GPS receiver 13.

The portable terminal 30 may calculate the current position of the vehicle using at least one piece of position information of the corrected current position received from the onboard apparatus 10 and the current position detected by the GPS receiver 31, and may create the route guidance information based on the calculated current position of the vehicle and the map information. When the receive state of the GPS receiver 31 of the portable terminal 30 is good, the current position detected by the GPS receiver 31 can be used.

The Wi-Fi communication unit 36a (corresponding to an example of the map information acquisition unit (means)) of the portable terminal 30 may acquire the map information divided for each predetermined section from the center server 50. Then, the communication unit 36 (corresponding to an example of the map information transmitting unit (means)) of the portable terminal 30 may transmit to the onboard apparatus 10 the map information of a predetermined range among the acquired pieces of the map information. The predetermined range consists of divided sections centering on the section in which the vehicle is located among the acquired pieces of the map information. The onboard apparatus 10 may store the map information transmitted by the communication unit 36 of the portable terminal 30 to the map database 14 (a map information storage unit) in which the vehicle map information is not stored. Then, the navigation unit 21 may create the route guidance information based on the map information stored in the map database 14 of the onboard apparatus 10, the current position detected by the GPS receiver 13, and the position change information detected by the gyro sensor 11 and the vehicle speed sensor 12.

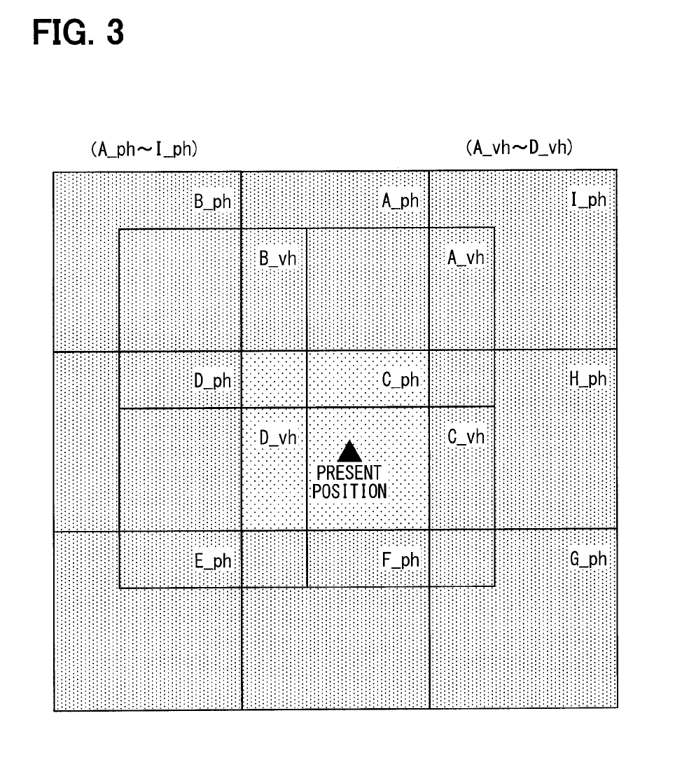

FIG. 3 illustrates the range of the map information which the communication unit 36 of the portable terminal 30 transmits to the onboard apparatus 10. The Wi-Fi communication unit 36a of the portable terminal 30 transmits to the onboard apparatus 10 the map information of divisions A_ph-I_ph centering on a division C_ph in which the vehicle is located. The divisions A_ph-I_ph include the vehicle-side divisions A_vh-D_vh which overlap with the division C_ph in part.

According to this structure, it is possible to transmit, from the portable terminal 30 to the onboard apparatus 10, the map information of the division of the predetermined range in which the division of the current vehicle position is at the center and a position to which the vehicle moves next is included. Therefore, it is possible to suppress the frequency at which the map information is transmitted from the portable terminal 30 to the onboard apparatus 10; consequently, it is also possible to suppress the communication load of the onboard apparatus 10. The map information which the portable terminal 30 acquires from the center server 50 is the newest map information. Therefore, the onboard apparatus 10 can perform the route guidance in keeping with the actual road state.

The Wi-Fi communication unit 36a (corresponding to an example of the map information acquisition unit (means)) of the portable terminal 30 may acquire, from the center server 50, the map information divided for every predetermined section and the change degree of each divided section of the map information. The communication unit 36 (corresponding to an example of the map information transmitting unit (means)) of the portable terminal 30 may transmit to the navigation unit 21 the map information of specific sections among the acquired map information. Each specific section has a larger change degree than a specified value. The navigation unit 21 may create the route guidance information, based on the map information belonging to a division with a larger change degree than the specified value and transmitted from the communication unit 36 of the portable terminal 30, the vehicle map information belonging to the ranges other than the above-described division and stored in the map database 14, the current position detected by the GPS receiver 13, and the position change information detected by the gyro sensor 11 and the vehicle speed sensor 12.

According to this structure, the map information transmitted from the portable terminal 30 to the onboard apparatus 10 is restricted to the map information of a division with a larger change degree than the specified value. Therefore, it is possible to suppress the traffic. In the division with a larger change degree than the specified value, the newest map information acquired from the center server 50 is used. Therefore, the onboard apparatus 10 can perform the route guidance in keeping with the actual road state. Note that the change degree designates the rate of areas which have changed due to a newly constructed road or a road ceased to be used, and the number of places which have changed, in a predetermined period.

The microcomputer of the navigation unit 21 may have a function to create the corrected current position but does not have the function to create the route guidance information. In addition, the onboard apparatus 10 may not have the map database 14. Such an onboard apparatus can also display on the image display unit 15 the route guidance information created by the portable terminal 30, and can perform the route guidance with a high degree of accuracy.

The onboard apparatus described above does not use the normal catalog. However, by preparing two catalogs, the normal catalog and the small catalog, the onboard apparatus described above can be changed in type to the onboard apparatus which can display the route guidance information created by the onboard apparatus on the image display unit. Specifically, by factory or a dealer, the microcomputer of the navigation unit 21 may be changed to a microcomputer having the function to create the corrected current position and the function to create the route guidance information, and the map data may be stored in a memory. After changing the version of the hardware, the HMI of the onboard apparatus can use the normal catalog and can display on the image display unit the route guidance information created by the onboard apparatus.

Three or more catalogs which define the communication commands may be prepared according to the type of the onboard apparatus 10. For example, when the onboard apparatus 10 is a type without speech recognition function, a catalog to be prepared may be the one in which the communication command for speech recognition is not defined. When the onboard apparatus 10 is a type without audio function, a catalog to be prepared may be the one in which the communication command for audio is not defined. In this way, when many catalogs corresponding to each type of the onboard apparatus 10 are prepared, the HMI 23 can control the transmission and reception of data more finely. As a result, it is possible to suppress the communication load of the onboard apparatus more properly.

The embodiments and the structures of the present disclosure have been illustrated in the above; however, embodiments and structures according to the present disclosure are not limited to respective embodiments and structures described above. Embodiments and structures which are obtained by combining suitably technical components disclosed in different embodiments and structures are also within the scope of embodiments and structures of the present disclosure.

1. A navigation system comprising:
a self-contained navigation sensor that is mounted in a vehicle and detects position change information of the vehicle;
a portable terminal that includes a GPS receiver to detect a current position, and creates and transmits route guidance information for a destination; and
an onboard apparatus that is mounted in the vehicle and displays on a display unit the route guidance information received from the portable terminal,
wherein the onboard apparatus creates a corrected current position based on the current position detected by the GPS receiver and the position change information detected by the self-contained navigation sensor, and transmits the corrected current position to the portable terminal, and
wherein the portable terminal creates the route guidance information based on the corrected current position received from the onboard apparatus and map information.

2. The navigation system according to claim 1, wherein
the corrected current position includes longitude and latitude.

3. The navigation system according to claim 1, wherein
the onboard apparatus comprises
a route creation unit that creates the corrected current position and the route guidance information for the destination based on the map information, the current position detected by the GPS receiver, and the position change information detected by the self-contained navigation sensor;
a relay unit that is operable to relay data exchange with the portable terminal and to perform data exchange with the route creation unit; and
a controller that is operable to perform data exchange with the route creation unit and the relay unit, and controls the data exchange performed by the route creation unit and the relay unit and controls display of the route guidance information on the display unit, and
wherein, when the controller displays on the display unit the route guidance information created by the portable terminal, the controller allows the route creation unit to transmit the corrected current position to the portable terminal and restricts the route creation unit from transmitting data other than the corrected current position.

4. The navigation system according to claim 3, wherein
when the controller displays on the display unit the route guidance information created by the portable terminal, the controller stops the route creation unit from transmitting the map information and the route guidance information to the controller.

5. The navigation system according to claim 3, wherein
when the controller displays on the display unit the route guidance information created by the portable terminal, the controller controls the transmission of the corrected current position so that the corrected current position is transmitted from the route creation unit to the portable terminal not through the controller but through the relay unit.

6. The navigation system according to claim 3, wherein:
the onboard apparatus stores a configuration defining which one of the route guidance information created by the portable terminal and the route guidance information created by the route creation unit should be displayed on the display unit; and
when the route guidance is started, the controller displays the route guidance information on the display unit, according to the stored configuration.

7. The navigation system according to claim 1, wherein:
the portable terminal transmits the current position detected by the GPS receiver to the onboard apparatus; and
the onboard apparatus creates the corrected current position based on the current position received from the portable terminal and the position change information detected by the self-contained navigation sensor, and transmits the corrected current position to the portable terminal.

8. The navigation system according to claim 3,
wherein the portable terminal comprises
a map information acquisition unit that acquires the map information divided on a predetermined section-by-section basis from a center server; and
a map information transmitting unit that transmits to the onboard apparatus the map information in a predetermined range among the map information acquired by the map information acquisition unit, the predetermined range consisting of divided sections centering on a division where the vehicle is located,
wherein the onboard apparatus comprises
a map information storage unit storing the map information transmitted by the map information transmitting unit,
wherein the route creation unit creates the route guidance information based on the map information stored in the map information storage unit, the current position detected by the GPS receiver, and the position change information detected by the self-contained navigation sensor.

9. The navigation system according to claim 3,
wherein the portable terminal comprises
a map information acquisition unit that acquires the map information divided on a predetermined section-by-section basis and a change degree of the map information of each divided section from a center server; and
a map information transmitting unit that transmits to the route creation unit the map information of a specific divided section from among the map information acquired by the map information acquisition unit, the specific divided section having the change degree larger than a specified value,
wherein the onboard apparatus comprises a map storage unit that stores onboard map information,
wherein the route creation unit creates the route guidance information based on the map information of the specific divided section transmitted by the map information transmitting unit, the onboard map information of a range other than the specific divided section stored in the map storage unit, the current position detected by the GPS receiver, and the position change information detected by the self-contained navigation sensor.
